(19) United States
(12) Patent Application Publication
(10) Pub. No.: US 2008/0064288 A1
(43) Pub. Date: Mar. 13, 2008

(54) Sealing Apparatus for Discharge Lamps

(76) Inventor: Jenn-Wei Mii, Taipei City (TW)

Correspondence Address: WPAT, PC, 7225 BEVERLY ST., ANNANDALE, VA, 22003, US

(21) Appl. No.: 11/530,737

(22) Filed: Sep. 11, 2006

(51) Int. Cl. H01J 9/36; H01J 9/38

(52) U.S. Cl. 445/69; 445/70

(57) ABSTRACT

The present invention relates to a sealing apparatus of discharge lamps, and more particularly, to a sealing apparatus adapted to be applied at a sealing structure of an enclosure, such as a plasma display and a gas-filling bottle, for permanently sealing the same, which is substantially a multiunit tube, primarily comprising at least an evacuated metal tube and an evacuated alloy tube coupled to the evacuated metal tube by an airtight manner, being adapted to interface with an end of a tube connecting to a glass substrate of an enclosure, such as a plasma display or a discharge lamp.

### FIELD OF THE INVENTION

The present invention relates to a sealing apparatus of discharge lamps, and more particularly, to a sealing apparatus adapted to be applied at a sealing structure of an enclosure, such as a plasma display and a gas-filling bottle, for permanently sealing the same.

### BACKGROUND OF THE INVENTION

Generally, a discharge lamp is structured as a glass tube or envelop (referred as tube hereinafter) having electrodes arranged at the two ends thereof, which is substantially a glass tube filled with an inert gas and mercury vapor while the inner surface of the tube is coated with a fluorescent paint made of varying blends of phosphors. When the light is turned on, the electric power heats up the cathode of the fluorescent lamp enough for it to emit electrons. These electrons collide with and ionize inert gas atoms in the tube to form a plasma by a process of impact ionization. As a result of avalanche ionization, the conductivity of the ionized gas rapidly rises, allowing higher currents to flow through the lamp, and thus the mercury is then likewise ionized, causing it to emit light in the ultraviolet (UV) region. The UV light is absorbed by the fluorescent coating, which re-radiates the energy at lower frequencies to emit visible light.

Similarly, a plasma display panel (PDP) is an emissive flat panel display where light is created by phosphors excited by a plasma discharge between two flat panels of glass while an inert mixture of noble gases is used to filled the enclosure formed between the two flat glass panels.

Moreover, a gas-filling bottle is used for replenishing a gas of an discharge lamp while there is not enough gas in the discharge lamp.

Please refer to FIG. 10, which shows a conventional discharge lamp being subject to a gas filling process. As seen in FIG. 10, a most widely used structure for filling a discharge lamp is an interfacing tube 81, having one end coupled to the glass tube 80 of the discharge lamp and another end connected to a gas-filling device 91 through a connecting tube 90. It is noted that the connecting tube 90 can be a rubber tube or another glass tube. The gas-filling device 91 includes a discharging system 92, connected to the connecting tube 90 through a first air valve 94, and a filling system 93, connected to the connecting tube 90 through a second air valve 95. While processing a gas filling operation, the discharging system 92 is first being activated for evacuate unwanted gas inside the glass tube 80 while enabling the first air valve 94 to open and the second air valve 95 to close; thereafter, once the requisite vacuum level has been achieve, the filling system 93 is activated for filling in a gas into the glass tube 80 while enabling the first air valve 94 to close and the second air valve 95 to open.

After the gas filling operation is accomplished and the second air valve 95 is closed, referring to FIG. 10 and FIG. 11, a small annular area of the interfacing tube 91 is heated and softened until it collapses under the influence of atmospheric pressure and sealed the glass tube 80 thereby.

Nevertheless, as the interfacing tube 81 is made of glass and is required to be heated to a high temperature for softening and melting the same, the softening of the glass interfacing tube 81 will result the heated glass to generate a conceivable amount of vapor, carbon dioxide and other gases that are going to accumulate in the glass tube 80 and can not be discharged. In addition, those accumulated gases will have adverse affect on the pressure and coloration of the discharge lamp. For solving the aforesaid problems, the two electrodes 82 must be conducted for aging the two, i.e. for enabling those accumulated gases to be absorbed by the electrodes. However, the aging process may last several hours that not only adds significantly to the overall cost of manufacturing the discharge lamp, but also adds significantly to the difficulty of controlling the quality of the discharge lamp. Moreover, the sealing of glass tube 80 by the melting of glass interfacing tube 81 is difficult to control, and a poorly controlled sealing operation might cause leakage to happen at the instance of sealing. Besides, if the heated area of the glass interfacing tube 81 is too large that some portion of the soften glass may be break to open by atmospheric pressure that will cause a great amount of air to be sucked into the glass tube 80 and cause the whole process of manufacturing a discharge tube to fail.

As for the plasma display panel, its sealing operation is similar to those described above since the structure thereof is similar to the foregoing discharge lamp, and thus no detailed description is provided herein.

For those glass tubes, such as gas-filling bottle, since they are used only for replenish gases and there is no electrode arranged therein, the gases generated during the heating of glass as abovementioned are even harder to be removed.

In addition, as seen in FIG. 10, as the two electrodes 82 are arranged inside the glass tube 80 while separating from the same, each is connected to a conducing wire that is extending outwards away from the glass tube 80 and connecting to a power source. Such arrangement results a great manufacture difficulty since a slight error during the integrating of the electrodes 82 and the glass tube 80 will cause the whole discharge lamp to malfunction. Not to mention that, as the heat generated from the operating electrode can not be dissipated effectively, the heated electrodes will have a relative short operating life.

A number of references relating to the abovementioned problems can be found, but none, as will be seen, anticipated the present invention. Kuang-Lung Tsai et al. (U.S. Pat. No. 5,897,927, entitled “Seal for vacuum devices and methods for making same”) describes a method for permanently sealing an ultra-high vacuum within a glass enclosure, in which a simple metal tube is used whereas it is positioned to be partially inside a hole formed in one of the flat plates that forms the enclosure, while a glass frit paste is applied all around the glass metal interface and heated for softening the frit and thus becoming a glass-to-metal seal. Once the structure has cooled down, the attached metal tube can be pinched off to form a permanent seal. Although the aforesaid metal tube is preferred made of Kovar, alloy 426 or alloy 42, which are designed to be compatible with the thermal expansion characteristic of sealing to hard and soft glasses in respective, and the relative expansion coefficients of glass, metal, and frit are all carefully controlled, the metal tube that is too soft may deform and break while subjecting to a pressure difference, and the metal tube that is too hard may crack during the pinching off the metal tube by a crimping tool.

Therefore, it is in need of a sealing apparatus, which can be adapted to be applied at a sealing structure of an enclosure for permanently sealing the same.

### SUMMARY OF THE INVENTION

In view of the disadvantages of prior art, the primary object of the present invention is to provide a sealing apparatus, adapted to be applied at a sealing structure of an enclosure, such as a discharge lamp, plasma display and a gas-filling bottle, for permanently sealing the same while preventing the generation of unwanted gases during a sealing process and thus enhancing the yield thereof.

It is another object of the invention to provide a sealing apparatus with sealing and connecting abilities, that is capable of facilitating the assembly of electrodes and reducing the working temperature of the assembled electrodes.

To achieve the above objects, the present invention provides a sealing apparatus adapted to be applied at an end of an interfacing tube of an enclosure, such as a plasma display and a discharge tube, for permanently sealing the same, which is substantially a multiunit tube, primarily comprising at least an evacuated metal tube and an evacuated alloy tube coupled to the evacuated metal tube by an airtight manner.

Preferably, an electrode is fixedly arranged at an end of the multiunit tube positioned inside the enclosure while a conducting wire is connected to a location of the multiunit tube positioned outside the enclosure.

In a preferred embodiment, after a gas replenishing operation is accomplished, the multiunit tube is pinched off using a suitable crimping tool, that is, the end of the multiunit tube outside the enclosure is squelched until the inner surface of the tube that are being pushed together meet and then fuse as cold weld, by witch the multiunit tube is sealed without suffering the problem of unwanted gases as those generated during the heating and softening of conventional glass interfacing tubes, and thus no gettering procedure is required so that the manufacturing cost can be significantly reduced and the product quality can be ensured.

Moreover, as the electrode is integrally formed at an end of the multiunit tube, no conducing wire, connecting thereto and extending outwards away from the enclosure, is required, so that the assembly of electrodes is facilitated and thus the manufacturing cost is reduced. In addition, as the electrode is directly arranged at an end of the multiunit tube, it working temperature can be greatly reduced by a radiator that reduce the happening of sputtering of the electrode caused by high temperature, and thus the lifespan of the electrode is prolonged. It is noted that the integrating of the electrode with the multiunit tube is a simple and instinctive task which will not complicate its manufacturing process.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a full sectional view of a sealing apparatus according to a first embodiment of the invention.

FIG. 2 is a full sectional view of a sealing apparatus according to a second embodiment of the invention.

FIG. 3 is an enlarged view of FIG. 1.

FIG. 4 is an enlarged view of FIG. 2.

FIG. 5 is a full sectional view of a sealing apparatus according to a third embodiment of the invention.

FIG. 6 is a full sectional view of a sealing apparatus according to a fourth embodiment of the invention.

FIG. 7 is a full sectional view of a sealing apparatus according to a fifth embodiment of the invention.

FIG. 8 is a full sectional view of a sealing apparatus according to a sixth embodiment of the invention.

FIG. 9 shows the operation of sealing apparatuses of different embodiments of the invention.

FIG. 10 is a full sectional view of a conventional sealing apparatus.

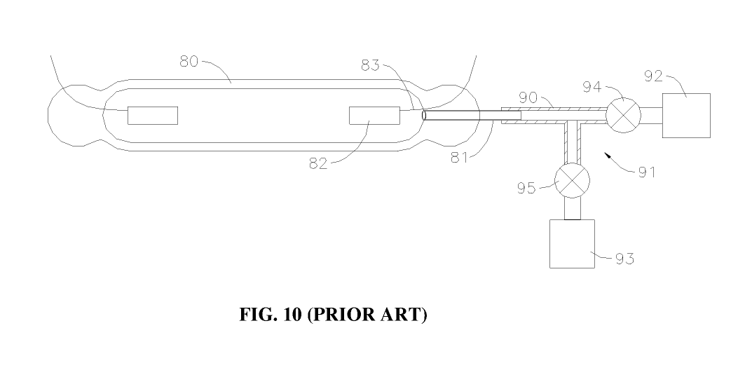

FIG. 11 is an enlarged view of FIG. 10.

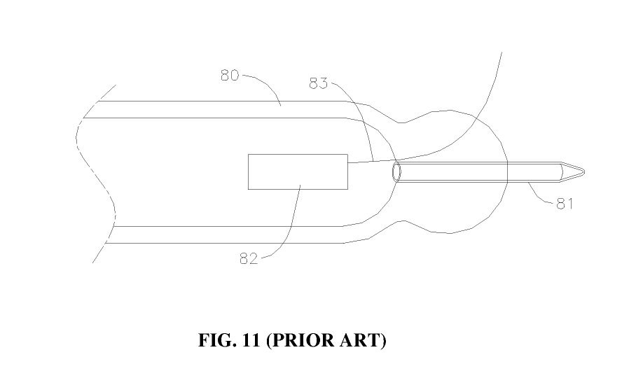

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

The sealing apparatus of discharge lamps, disclosed in the present invention, is substantially a multiunit tube, primarily comprising at least an evacuated metal tube and an evacuated alloy tube coupled to the evacuated metal tube by an airtight manner, being adapted to interface with an end of a tube connecting to a glass substrate of an enclosure, such as a plasma display or a discharge lamp.

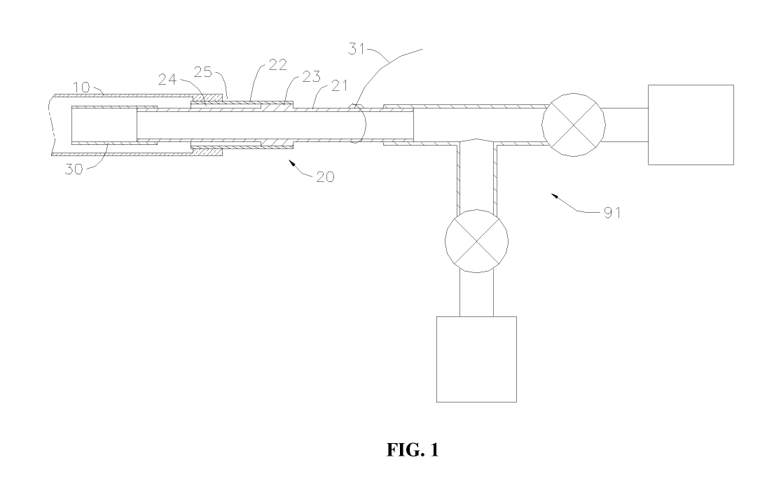

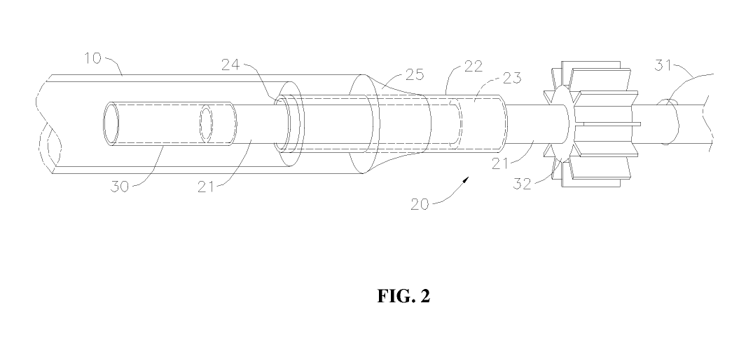

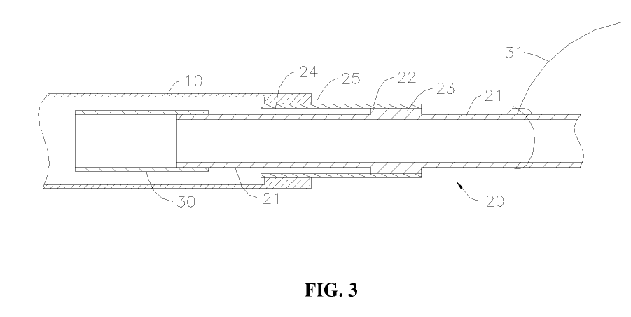

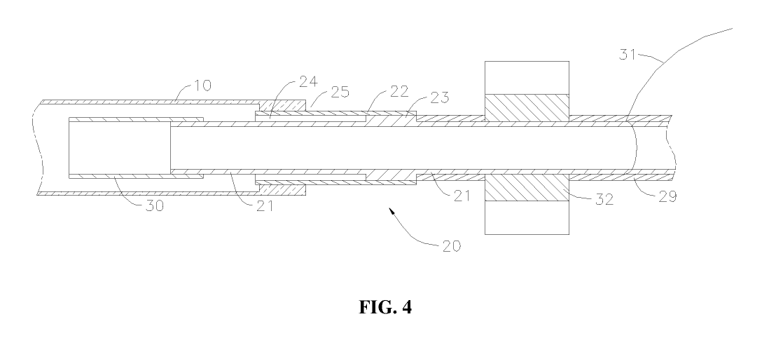

Please refer to FIG. 1 to FIG. 4, which show two embodiments of the present invention. As seen, a sealing apparatus is arranged at an interfacing end of the glass tub 10 of a discharge lamp, which is substantially a multiunit tube 20 composed of a copper tube 21 and an alloy tube 22 ensheathing the copper tube 20. The alloy tube 22 is fused to coupled to the interfacing end of the glass tube 10 in an airtight manner while a portion of the outer surface of the copper tube 21 is fused to coupled with the alloy tube 22 in an airtight manner at a position thereof opposite to the coupled area of the ally tube 22 and the interfacing end. Moreover, a connecting block 23, integrally formed with the copper tube 21 at the outer surface thereof, is enabled to contact with the alloy tube 22 for coupling the two while enabling the other portion of the outer surface of the copper tube 21 to separate from the inner surface of the alloy tube 22 by a pitch 24. In addition, an electrode 30 is fixedly arranged at an end of the copper tube 21 positioned inside the glass tube 10 while a conducting wire 31 is connected to a location of the copper tube positioned outside the glass tube 10. It is noted that another end of the copper tube 21 that is not formed with the electrode 30, is further connected to a conventional gas-filling device 91. Furthermore, as the embodiment shown in FIG. 2 and FIG. 4, a heat dissipating device 32 with a plurality of heat dissipating fins is arranged on the copper tube 21 at a location outside the glass tube 10, and an insulating heat conduction rubber 29 is arranged at a portion of the copper tube 21 outside the glass tube 10 for preventing electric leakage.

As the abovementioned sealing apparatus is a multiunit tube 20, it can be pinched off using a suitable crimping tool, that is, the end of the multiunit tube outside the enclosure is squelched until the inner surface of the tube that are being pushed together meet and then fuse as cold weld, by witch the multiunit tube is sealed without suffering the problem of unwanted gases as those generated during the heating and softening of conventional glass interfacing tubes. Moreover, as the electrode 30 is arranged directly at an end of the multiunit tube 20 positioned inside the glass tube 10, it can be positioned and oriented with preferred accuracy. Further, as the electrode 30 is arranged directly at the copper tube 21 of the multiunit tube 20, the heat generated from the electrode 30 can be transmitted through the multiunit tube 20 and out of the glass tube 10, where the heat can be dissipated rapidly by the heat dissipating device 32 arranged on the copper tube 21, and thus the lifespan of the discharge lamp can be prolonged. Since the conducing wire 31 is connected to a location of the copper tube 21 positioned outside the glass tube 10, it is simple in structure and thus is easy to manufacture. Nevertheless, as the pitch 24 is formed between the copper tube 21 and the alloy tube 22 at the coupling position of the alloy tube 22 and the glass tube 10, the expanded copper tube by heating the same will not push the alloy tube 22 to further press the glass tube 10 and thus the cracking of the glass tube 10 can be prevented.

In a preferred aspect, a sealer 25 is coated at a position corresponding to the outside of the coupling position of the alloy tube 22 and the interfacing end of the glass tube 10, which is used for further ensuring leakage.

In addition, the aforesaid multiunit tube 20 can further coupled to another metal tube of a specific characteristic in an airtight manner, and thus forms another multiunit tube, in which the multiunit tube 20, referred as the first tube, can be fused to coupled with glass tube; and the metal tube of specific characteristic, referred as the second tube, can be squelched without cracking and is suitable for connecting the same to a rubber hose for facilitating a gas-filling procedure. Moreover, an extension of the second tube can be coupled to a third tube in an airtight manner, which can facilitating a gas-discharging/filling operation during fusing a glass tube in high temperature and high pressure. It is noted that the sealing of the glass tube is designed to performed on the second tube. In a preferred aspect, the aforesaid metal tube can be an oxygen-free-copper (OFC) tube, a metal tube with copper coating, a metal tube with nickel coating, or a ferro-nickel alloy tube, or it can be a soft, squashable alloy tube with preferred thermal conductivity, or can be a tube having a solid metal bar attached to an end thereof adapted for the electrode. Preferably, the alloy tube can be made of Kovar, or alloy 426.

The multiunit tube of the invention can be implemented in a conventional gas-replenishing operation, since it can be pinched off at the middle or tail thereof while being fused to seal without causing any gas, that is harmful to the quality of discharge lamp, to generate.

Except for the expansion coefficient is proximate to that of glass, the alloy tube 22 of the multiunit tube 20 is also characterized in that: it is easy to form a oxidizing layer thereon for facilitating the same to fuse with glass. Moreover, the copper tube 21 has good malleability and flexibility, it can be easily squelched until the inner surface of the tube that are being pushed together meet and then fuse as cold weld, and still without splitting or cracking. Preferably, the copper tube 21 is an OFC tube, and the alloy tube 22 can be made of alloy 426, or Kovar, nevertheless, such alloy tube has poor malleability that it is too hard for the operation of being squelched until the inner surface of the tube that are being pushed together meet and then fused as cold weld.

In another preferred embodiment, the end of the copper tube 21 of the multiunit tube 20 positioned outside the glass tube 10 can be further coupled to a plurality of metal tubes or alloy tubes, which together can operate similar to that shown in the forgoing embodiments.

As the squelching and fusing is perform on the multiunit tube 20, the multiunit tube 20 can be sealed without suffering the problem of unwanted gases as those generated during the heating and softening of conventional glass interfacing tubes, and thus no gettering or aging procedure is required so that the manufacturing cost can be significantly reduced and the product quality can be ensured.

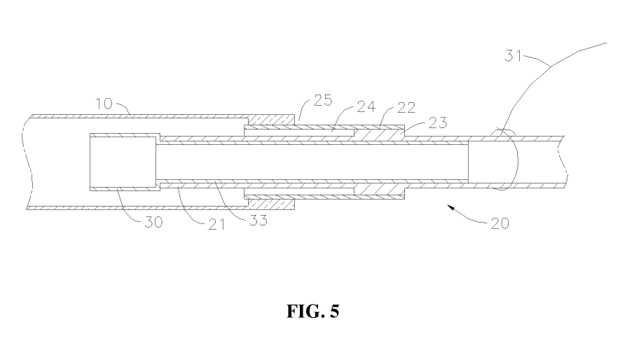

Please refer to FIG. 5, which is a full sectional view of a sealing apparatus according to a third embodiment of the invention. As seen in FIG. 5, an electrode 30, similar to that shown in FIG. 5, is attached at a structure arranged at an end of the copper tube 21 of a multiunit tube 20, that the structure is substantially an assembly tube extending from the end of the copper tube 21 toward the interior of the copper tube 21 while contacting to the inner surface thereof. By the designing of the foregoing assembly tube 33, the contact surface of the electrode 30 and the copper tube 21 is increased and thus the heat dissipation efficiency is improved.

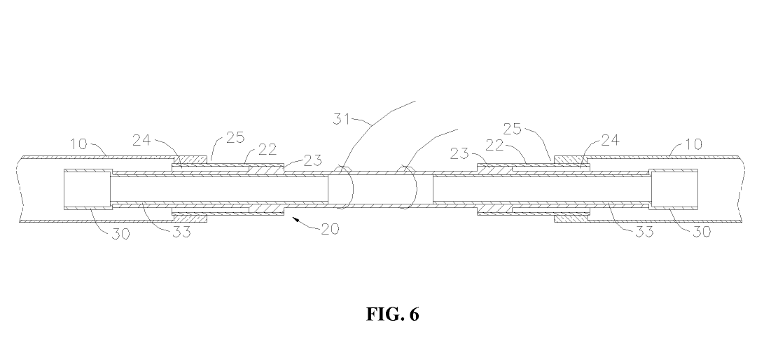

Please refer to FIG. 6, is a full sectional view of a sealing apparatus according to a fourth embodiment of the invention. The sealing apparatus of the fourth embodiment shown in FIG. 6 can be used for connecting two different discharge lamps, whose structure is similar to those abovementioned embodiments, but is different in that: both end of the copper tube 21 are ensheathed respectively by alloy tubes 22 suitable for connecting the same to glass tubes 10 while each end is configured with an electrode 30 for discharging electrons into its corresponding discharge lamp.

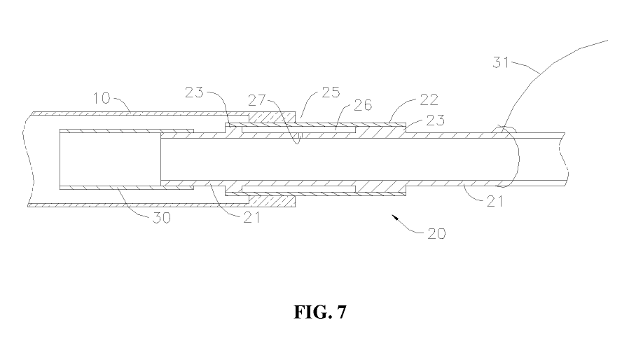

Please refer to FIG. 7, which is a full sectional view of a sealing apparatus according to a fifth embodiment of the invention. In the fifth embodiment, two connecting blocks 23 are arranged at the outer surface of the copper tube 21 while separating from each other by a distance, each connecting block being enabled to coupled to the ally tube 22 at a position thereof different to the coupled area of the ally tube 22 and the glass tube 10, by which a sealed enclosure 26 is formed between the copper tube 21 and the alloy tube 22. In addition, a via hole 27 is arranged at the copper tube 21 at a position thereof corresponding to the sealed enclosure 26, through which air trapped in the sealed enclosure 26 can be evacuated. It is noted that the abovementioned copper tube 21 is connected to the alloy tube 22 by two connecting blocks, such that the copper tube 21 can be stably and rigidly coupled to the allot tube 22 without shaking.

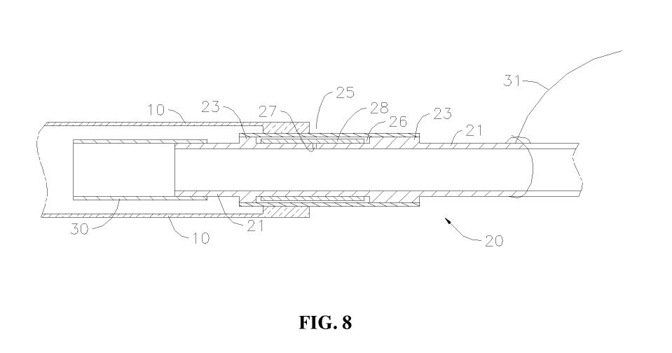

Please refer to FIG. 8, which is a full sectional view of a sealing apparatus according to a sixth embodiment of the invention. The sealing apparatus of FIG. 8 is similar to that shown in FIG. 7, but the only difference is that: there is a heat insulation sheet 28 being arranged inside the sealed enclosure 26, by which the heat insulation at the interface of the copper tube 21 and the glass tube 10 is improved and thus cracking on the glass tube 10 as it is affected by the heated copper tube 21 can be prevented.

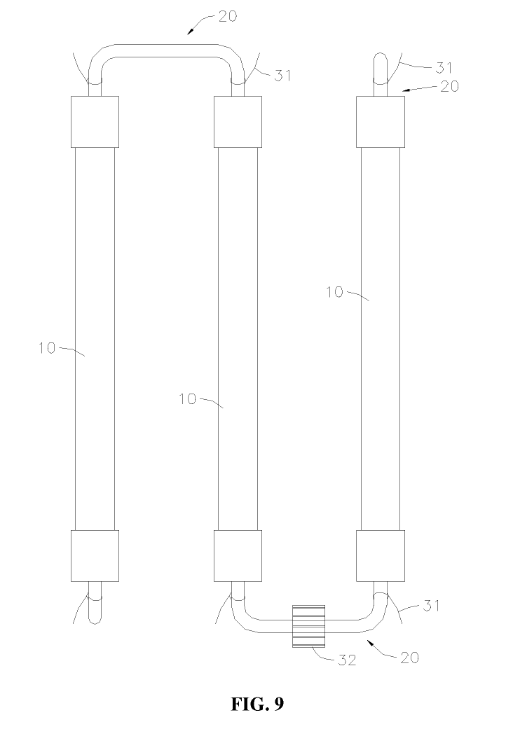

Please refer to FIG. 9, which shows the operation of sealing apparatuses of different embodiments of the invention. In FIG. 9, there are three glass tubes 10 of different discharge lamps while any two of the three glass tubes 10 are connected by a multiunit tube 20 of the invention. Moreover, since the multiunit tubes 20, connecting any two glass tubes 10, are not sealed, the three discharge lamps considered to be serially connected. As the electrode of the multiunit tube 20 of the invention is directly arranged at an end thereof, the conventional operations of arranging electrodes inside glass tube and then proceeding with guiding the conducting wire out of the glass tube can be waived, and thus the operation of serial-connecting a plurality of discharge lamps can be facilitated and the manufacture cost is reduced. It is noted that the two sealing apparatuses arranged at the two end of the serial-connected discharge lamp structure is sealed. In the embodiment shown in FIG. 9, it is advantageous in that the plural discharge lamp can be evacuated can be accomplished by an individual evacuation process, and thus the pressure of each of the plural discharge lamp can be keep the same for enabling each discharge lamp to have the same brightness, which is greatly appreciated as they are applied in backlight modules.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A sealing apparatus, adapted for a sealing/connecting operation of a discharge tube, being characterized in that: it is substantially a multiunit tube, primarily comprising at least a metal tube and at least an alloy tube coupled to the at least one metal tube by an airtight manner.

2. The sealing apparatus of claim 1, wherein the at least one ally tube is coupled to a glass interfacing end of the discharge tube in an airtight manner while a portion of the outer surface of the at least one metal tube is fused to coupled with the at least one alloy tube in an airtight manner at a position thereof opposite to the coupled area of the ally tube and the glass interfacing end and the other portion of the outer surface of the at least one metal tube is enabled to separate from the inner surface of the at least one alloy tube; and an electrode is fixedly arranged at an end of the at least one metal tube positioned inside the discharge lamp while a conducting wire is connected to a location of the at least one metal tube positioned outside the discharge lamp.

3. The sealing apparatus of claim 2, wherein a sealed enclosure is formed between the alloy tube and the metal tube as the two positions of the outer surface of the metal tube, being separated from each other by a distance, are coupled with the alloy tube respectively at a position thereof opposite to the coupled area of the ally tube and the glass interfacing end.

4. The sealing apparatus of claim 3, wherein a via hole is arranged at the at least one metal tube at a position thereof corresponding to the enclosure.

5. The sealing apparatus of claim 2, wherein a connecting block, integrally formed with the at least one metal tube at the outer surface thereof, is enabled to contact with the at least one alloy tube for coupling the two.

6. The sealing apparatus of claim 3, wherein heat insulation sheets are arranged inside the enclosure.

7. The sealing apparatus of claim 1, wherein a heat dissipating device with a plurality of heat dissipating fins is arranged on the at least one metal tube at a location outside the discharge lamp.

8. The sealing apparatus of claim 2, wherein the fixing of the electrode at an end of the at least one metal tube positioned inside the discharge lamp is achieved by an assembling tube, being substantially a tube extending from the end of the at least one metal tube inside the discharge lamp toward the inside of the discharge lamp while contacting to the inner surface of the at least one metal tube.

9. The sealing apparatus of claim 2, wherein the fixing of the electrode at an end of the at least one metal tube positioned inside the discharge lamp is achieved by an assembling tube, being substantially a tube extending from the end of the at least one metal tube inside the discharge lamp toward the outside of the discharge lamp while contacting to the outer surface of the at least one metal tube.

10. The sealing apparatus of claim 2, wherein a sealer is coated at a position corresponding to the outside of the coupling position of the at least one alloy tube and the glass interfacing end of the discharge lamp.

11. The sealing apparatus of claim 1, wherein an insulation layer is coated on the outer surface of the at least one alloy tube.

12. The sealing apparatus of claim 1, wherein each metal tube is an oxygen-free-copper (OFC) tube.

13. The sealing apparatus of claim 1, wherein each metal tube is a metal with copper coating.

14. The sealing apparatus of claim 1, wherein each metal tube is a metal with nickel coating.

15. The sealing apparatus of claim 1, wherein each metal tube is a soft, squashable alloy tube with preferred thermal conductivity.

16. The sealing apparatus of claim 1, wherein each metal tube is a solid metal bar.

17. The sealing apparatus of claim 1, wherein each alloy tube is a ferro-nickel alloy tube.

18. The sealing apparatus of claim 1, wherein an insulating material is arranged at a portion of the at least one metal tube outside the discharge lamp.

19. The sealing apparatus of claim 18, wherein the insulating material is an insulating heat conduction rubber.
